(19) United States
(12) Patent Application Publication
(10) Pub. No.: US 2026/0095913 A1
(43) Pub. Date: Apr. 2, 2026

(54) DATA TRANSMISSION IN ENERGY EFFICIENT SCHEDULING GAP SLOTS

(71) Applicant: QUALCOMM Incorporated, San Diego, CA (US)

(72) Inventors: Diana MAAMARI, San Diego, CA (US); Gabi SARKIS, San Diego, CA (US); Peter GAAL, San Diego, CA (US); Jing JIANG, San Diego, CA (US)

(21) Appl. No.: 18/904,643

(22) Filed: Oct. 2, 2024

(51) Int. Cl. H04W 72/1273; H04L 1/00; H04W 72/0446

(52) U.S. Cl. CPC H04W 72/1273; H04L 1/0003; H04W 72/0446

(57) ABSTRACT

Certain aspects of the present disclosure provide techniques for data transmission in energy efficient scheduling gaps. An example method performed by a user equipment (UE) includes receiving a first control configuration that configures a first peak throughput for a first downlink transmission to be received by the UE and receiving a second control configuration that configures at least one or more gap slots and a second peak throughput, for at least a second downlink transmission to be received by the UE, that is less than the first peak throughput. The method further includes receiving at least the second downlink transmission in a first slot in accordance with the second control configuration and receiving at least a third downlink transmission in the one or more gap slots based on a scheduled downlink transmission throughput associated with the first slot being less than the second peak throughput.

### BACKGROUND

### Field of the Disclosure

Aspects of the present disclosure relate to wireless communications, and more particularly, to techniques for data transmission in energy efficient scheduling gap slots.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving, from a network entity, a first control configuration that configures a first peak throughput for at least a first downlink transmission to be received by the UE; receiving, from the network entity, a second control configuration that configures at least: a second peak throughput, for at least a second downlink transmission to be received by the UE, that is less than the first peak throughput indicated by the first control configuration one or more gap slots that consecutively follow the second downlink transmission; receiving, from the network entity, at least the second downlink transmission in a first slot in accordance with the second control configuration, wherein a scheduled downlink transmission throughput associated with the first slot is less than the second peak throughput; and receiving, from the network entity, at least a third downlink transmission in the one or more gap slots based on the scheduled downlink transmission throughput associated with the first slot being less than the second peak throughput.

Another aspect provides a method for wireless communication by a network entity. The method includes transmitting, to a user equipment (UE), a first control configuration that configures a first peak throughput for at least a first downlink transmission to be received by the UE; transmitting, to the UE, a second control configuration that configures at least: a second peak throughput, for at least a second downlink transmission to be received by the UE, that is less than the first peak throughput indicated by the first control configuration one or more gap slots that consecutively follow the second downlink transmission; transmitting, to the UE, at least the second downlink transmission in a first slot in accordance with the second control configuration, wherein a scheduled downlink transmission throughput associated with the first slot is less than the second peak throughput; and transmitting, to the UE, at least a third downlink transmission in the one or more gap slots based on the scheduled downlink transmission throughput associated with the first slot being less than the second peak throughput.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 shows an example of a communications timeline that supports energy efficient scheduling, in accordance with one or more aspects of the present disclosure.

FIG. 6 depicts a process flow including operations for communications in a network between a network entity and a user equipment (UE).

FIG. 7 includes a communications timeline that supports energy efficient scheduling and the scheduling of downlink transmissions in one or more gap slots.

FIG. 8 depicts a method for wireless communications.

FIG. 9 depicts a method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for data transmission in energy efficient scheduling gap slots.

For example, in some cases, a user equipment (UE) may receive and process network transmissions according to defined timelines. For transmissions received in a narrowband (NB) bandwidth part (BWP), the timeline is typically longer, providing the UE with ample time to process the data and send feedback. In contrast, transmissions received in a wideband (WB) BWP follow a shorter timeline, requiring quicker processing and response. To handle the higher data throughput of WB transmissions, the UE may enter a high-power mode, increasing its baseband clock frequency and voltage, which significantly raises power consumption due. However, when WB transmissions are relatively scheduled infrequently, maintaining the UE in high-power mode can lead to unnecessary energy consumption. To address this, an “energy-efficient scheduling” technique can be used to extend the processing timeline for WB transmissions, allowing the UE to process the data over multiple gap slots at a lower clock frequency and voltage, thus reducing power consumption. During these gap slots, the UE may still monitor for downlink control information (DCI) in the physical downlink control channel (PDCCH), but the DCI may not schedule the UE to receive downlink transmissions during these slots to prevent a receive buffer of the UE from being overloaded.

However, preventing the UE from being scheduled to receive downlink transmissions in the one or more gap slots may lead to resource usage inefficiencies, in some cases. For example, there may be some scenarios where a scheduled downlink transmission throughput in a particular slot of the WB BWP is less than a peak data throughput supported by the WB BWP, leaving some unused capacity in the receive buffer of the UE that could have been used by other transmissions. In other words, the downlink transmissions scheduled in the slot may not fully utilize the peak data throughput that is supported by the WB BWP, which may result in time-frequency resources being inefficiently utilized and poor user experience.

Accordingly, aspects of the present disclosure provide techniques for reducing time-frequency resource wastage in scenarios in which, when energy efficient scheduling is being used, a scheduled downlink transmission throughput associated with a slot of a BWP in which one or more downlink transmissions are scheduled is less than a peak data throughput supported by the BWP. For example, in some cases, these techniques may include scheduling one or more subsequent or additional downlink transmissions having a small packet size and relatively low latency within one or more gap slots. Additionally, aspects of the present disclosure provide techniques for avoiding or at least reducing a risk that a receive buffer of a UE is overloaded when the one or more subsequent or additional downlink transmissions are scheduled in the one or more gap slots.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

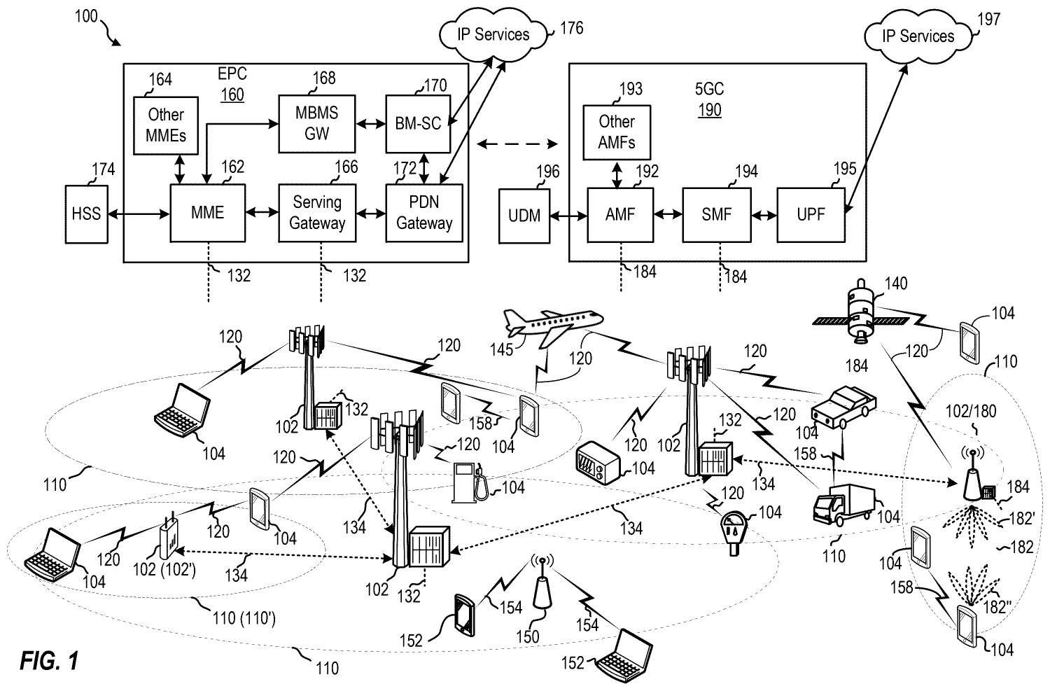

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

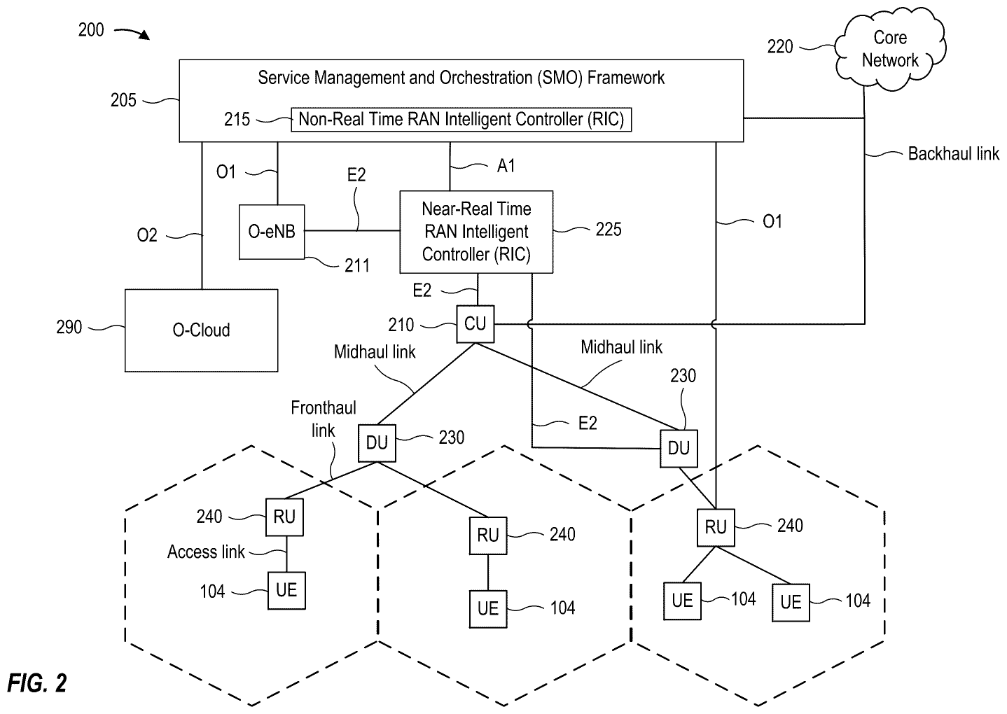

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MH2, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

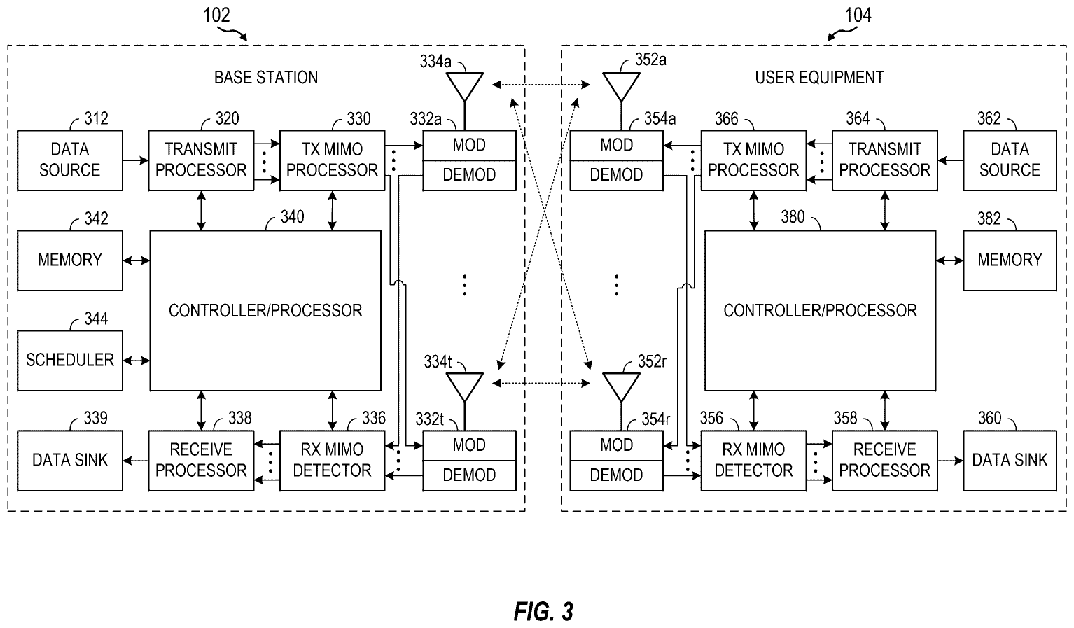

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

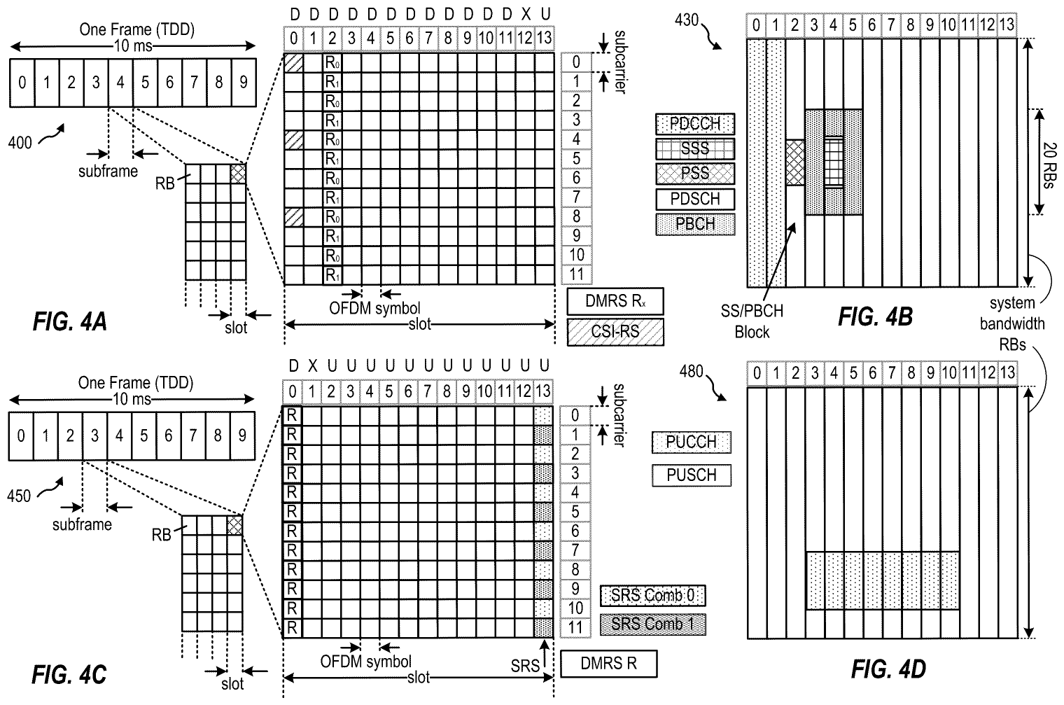

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2_{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Efficient Scheduling

Fifth generation (5G) new radio (NR) introduced the concept of a bandwidth parts (BWP), which refers to a specific subset of a carrier bandwidth that a user equipment (UE) or network can operate within. For example, instead of using the entire carrier bandwidth at all times, BWPs allow the network to configure and allocate smaller segments of the available spectrum dynamically. BWPs may enable the network to create different sets of configuration parameters for both downlink reception and uplink transmission, with the flexibility to switch between these sets. These parameters include the maximum bandwidth for scheduling, the maximum rank, the maximum modulation order (configured by selecting the appropriate modulation and coding scheme (MCS) table), and other relevant aspects.

In some cases, a BWP may be configured to include either a narrow or wide portion of the available carrier bandwidth, allowing flexibility in resource allocation based on network needs or user requirements. For example, one BWP may define a narrow band (NB) including a narrower set of frequency resources of the carrier bandwidth, which may be associated with lower data throughput and reduced power consumption, while another BWP may encompass a wide band (WB) including a wider set of frequency resources of the carrier bandwidth, supporting higher data throughput for more demanding services.

In some cases, a peak data throughput associated with transmissions scheduled in the NB may be defined based on a first set of communication parameters associated with the NB. Similarly, a peak data throughput associated with transmissions scheduled in the WB may be defined based on a second set of communication parameters associated with the WB. In some cases, Equation 1, below, may be used to determine a peak data throughput for transmissions scheduled in a particular band or band combination (e.g., BWP) based on the sets of communication parameters.

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \frac{{N}_{PRB}^{BW ( j ) , μ} \cdot 12}{{z}^{( j )} {T}_{s}^{μ}} ( 1 - O {H}^{( j )} ) ) \qquad ( 1 )$$

In Equation 1, j is a number of aggregated component carriers in a band or band combination, v is a maximum number of supported layers for downlink (DL) or uplink (UL), Qₘ is the maximum supported modulation order for DL/UL, f is a scaling factor, z is another scaling factor, BW(j) is the UE supported maximum bandwidth in the given band or band combination,

$${N}_{PRB}^{BW ( j ) , μ}$$

is the maximum RB allocation in bandwidth BW(j) with numerology μ, Tₛ is the average OFDM symbol duration in a subframe for numerology μ, Rₘₐₓ is the maximum code rate (e.g., 948/1024), and OH is an overhead for the number of aggregated component carriers j. In some cases, the scaling factor z may be used to extend the average OFDM symbol duration Tₛ, for example, by setting z to a value greater than 1.

In some cases, the first set of communication parameters associated with the NB may include a relatively lower bandwidth, a relatively lower rank or number of layers, and/or a relatively lower modulation order. Conversely, the second set of communication parameters associated with the WB may include a relatively higher bandwidth, a relatively higher rank or number of layers, and/or a relatively higher modulation order. Accordingly, based on Equation 1 and the relatively higher communication parameters associated with the WB, the WB may be associated with a higher peak data throughput relative to the NB.

In some cases, a network entity may utilize a minimum processing time when scheduling resources for acknowledgement or feedback information from a UE in response to a downlink transmission. For example, the minimum time between the end of a physical downlink shared channel (PDSCH) and the beginning of the physical uplink control channel (PUCCH) that includes feedback information for the PDSCH may be referred to as T_{proc,1}, which may be measured in milliseconds, and may be referred to as N₁ when measured in symbols. The minimum processing timeline, which may also be referred to as a PDSCH processing timeline or a feedback timeline, may represent a gap between the end of a data reception at the UE (e.g., PDSCH) and the beginning of a feedback opportunity (e.g., PUCCH resources) for transmission of feedback by the UE. In some cases, the UE may support one or more PDSCH processing capabilities, including, for example, a regular PDSCH processing capability and a fast PDSCH processing capability (e.g., an optionally supported fast capability associated).

In some cases, a minimum processing timeline associated with a WB PDSCH may be shorter than a minimum processing timeline associated with NB PDSCH. In other words, when receiving a WB PDSCH, the UE may be expected to process the WB PDSCH and transmit feedback information corresponding the WB PDSCH more quickly relative to an NB PDSCH.

In some cases, when the UE is scheduled to receive WB transmissions, the UE may be configured to enter a high-power mode in order to satisfy the shorter minimum processing timeline and higher peak data throughput associated with these WB transmissions. This transition may involve the UE increasing an internal baseband clock frequency and voltage to meet the demands associated with processing and acknowledging (e.g., transmitting feedback information) these WB transmissions. As a result, the UE may experience significantly higher power consumption while operating in this high-power mode, as the elevated clock frequency and voltage lead to a quadratic increase in dynamic power consumption, along with greater leakage.

Further, there may be scenarios in which, although the UE may be scheduled to receive WB downlink transmissions, these transmissions may be scheduled infrequently by the network entity. In such cases, if the UE were to remain in high-power mode continuously, this may lead to unnecessary power consumption for processing transmissions that are infrequently received. In other words, this may result in the UE expending energy to operate in the high-power state that is not justified by the actual frequency of the WB downlink transmissions.

Accordingly, in some cases, to help reduce this unnecessary power consumption, a technique referred to herein as “energy efficient scheduling” may be used. For example, when energy-efficient scheduling is used, the minimum processing timeline for WB downlink transmissions may be extended, allowing the UE additional time to receive, process, and transmit feedback for these transmissions. This additional time enables the UE to distribute the processing of these downlink transmissions across multiple slots. As a result, the UE may avoid entering a high-power state, instead processing the transmissions at a lower baseband clock frequency and voltage over a longer period of time.

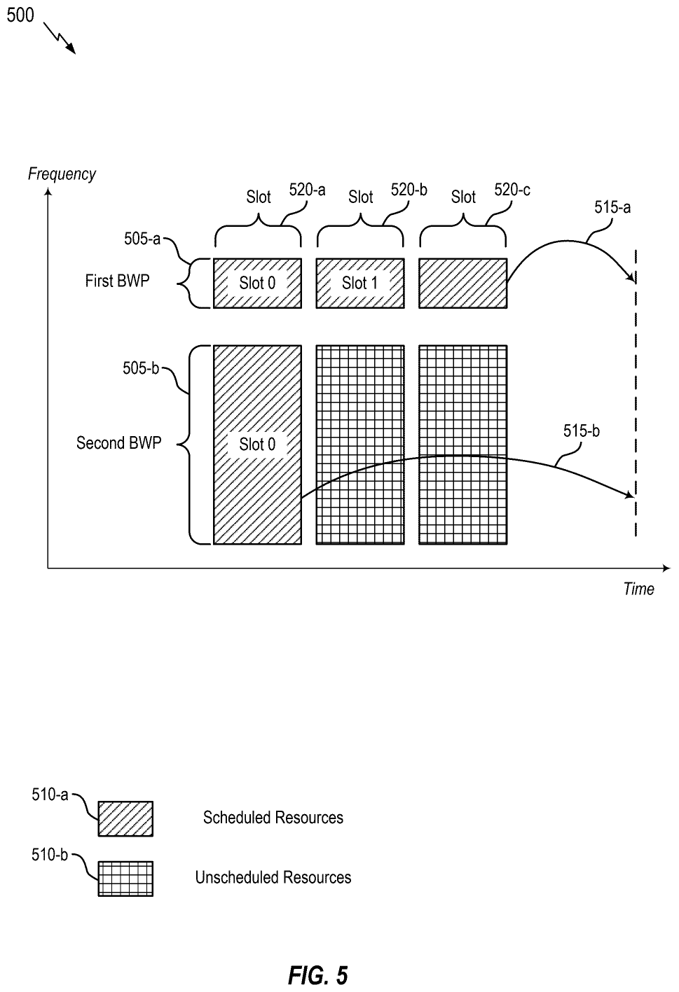

FIG. 5 shows an example of a communications timeline 500 that supports energy efficient scheduling in accordance with one or more aspects of the present disclosure. In some examples, communication timeline 500 may implement aspects of, or be implemented by aspects of, the wireless communications network 100. For example, a UE and a network entity, which may be examples of the UE 104 and BS 102 described with reference to FIG. 1, may communicate with each other according to the communication timeline 500.

In some cases, the UE may communicate in a first BWP 505-a (e.g., based on a first set of communication parameters, which also may be referred to as a first BWP configuration) associated with a narrow bandwidth (e.g., a narrowband operation mode (NB)). The maximum throughput may be limited by the maximum available bandwidth in the first BWP 505-a. In other words, the sustained throughput may be limited. The first BWP 505-a may additionally be associated with a minimum processing timeline 515-a, which may correspond to a shortest time period between an end of a message received at the UE and a beginning of a scheduled feedback opportunity. The UE may process the received message and generate feedback within the minimum processing timeline 515-a. Accordingly, the amount of data to decode within the minimum processing timeline 515-a (e.g., feedback timeline) may be relatively low as compared with longer processing timelines, which may be supported by the relatively limited bandwidth available for scheduling in the gap slot 520-c within the first BWP 505-a. In other words, instantaneous throughput may be limited.

In some cases, the UE may communicate in a second BWP 505-b (e.g., using a second set of communication parameters, which also may be referred to as a second BWP configuration) associated with a relatively wide bandwidth (e.g., wideband operation mode (WB)). The maximum or peak data throughput supported by the second BWP 505-b may be higher than the peak throughput associated with the first BWP 505-a since the second BWP 505-b may include a wider bandwidth. For example, relative to the first BWP 505-a, the network entity may transmit more data within a given time period using the second BWP 505-b using the wider bandwidth.

In some cases, since more data may be transmitted within a given time period using the second BWP 505-b, a minimum processing timeline for the second BWP 505-b may generally be shorter than the minimum processing timeline 515-a. In other words, because more data is transmitted within a given time period using the second BWP 505-b, the UE may be expected to more quickly process and transmit feedback information for this data, which may usually require the UE to enter the high-power mode and increase its baseband clock frequency and voltage, resulting in increased power consumption.

However, in some cases, to reduce power consumption, especially in scenarios in which the UE is scheduled relatively infrequently, energy efficient scheduling may be used. As discussed above, when using energy efficient scheduling, the minimum processing timeline for the second BWP 505-b may be extended to that of the minimum processing timeline 515-a. For example, as shown, the UE may be scheduled to receive one or more downlink transmissions within the scheduled resources 510-a of slot 520-a using the second BWP 505-b. The minimum processing timeline for one or more downlink transmissions within the scheduled resources 510-a of slot 520-a may then be extended or relaxed, as shown at 515-b, to be the same as the minimum processing timeline 515-a associated with first BWP 505-a.

As noted above, by extending or relaxing the minimum processing timeline for the one or more downlink transmissions within the scheduled resources 510-a of slot 520-a of the second BWP 505-b, the UE may not be required to increase its baseband clock frequency or voltage, instead processing the one or more downlink transmissions at a lower baseband clock frequency and voltage over a longer period of time, thereby reducing power consumption.

To further facilitate this relaxed processing timeline, the network entity may allocate one or more gap slots or symbols following the slot 520-a, such as gap slots 520-b and 520c, providing the UE additional time to complete baseband processing for the downlink transmissions received in slot 520-a. For example, in contrast to slot 520-a, gap slots 520-b and 520-c may include unscheduled resources 510-b, providing the UE additional time to complete the baseband processing for the downlink transmissions received in slot 520-a. The purpose of these gap slots may be to prevent conflicts in a receive buffer of the UE. For example, if the network entity were to schedule downlink transmissions in subsequent slots, such as gap slots 520-b and 520-c, there is a risk that the receive buffer of the UE may overflow, as the UE might still be processing the transmissions from slot 520-a. This could result in the data from slot 520-a being overwritten by new transmissions before processing is complete. To mitigate this, the network entity may inform the UE that it will not be scheduled for transmissions in gap slots 520-b and 520-c, ensuring that the UE can complete baseband processing without the risk of buffer overflow. These gap slots provide the necessary time for the UE to process all data from the buffer before new data is written, ensuring smooth operation and preventing any loss of transmission data.

In some cases, to enable energy efficient scheduling, the network entity may indicate, to the UE, that a maximum schedulable sustained throughput is lower than the peak data throughput for the current configuration profile. In some cases, the network entity may indicate a maximum schedulable sustained throughput is lower than the peak data throughput for the current configuration profile by indicating that the scaling factor z^{(j)} (e.g., in Equation 1, above) is greater than one. In some cases, the network entity may indicate a maximum schedulable sustained throughput is lower than the peak data throughput for the current configuration profile by indicating that the UE will only be scheduled to receive one or more downlink transmissions within slot 520-a rather than being scheduled to receive downlink transmissions within each of the gap slots 520-a, 520-b, and 520-c.

In some cases, to enable energy efficient scheduling, the network entity may indicate to the UE that the minimum processing (or feedback) timeline for the second BWP 505-b is larger than a minimum possible value reported by the UE. For example, in some cases, the network entity may indicate the N1 processing timeline plus X milliseconds (e.g., N1+X milliseconds). In some cases, to enable energy efficient scheduling, the network entity may indicate one or more gap slots, which may consecutively follow a downlink transmission, which may be used for baseband processing of the downlink transmission. In some cases, a number of the one or more gap slots may be based on capability information from the UE. For example, in some cases, the UE may indicate to the network entity how many PDSCHs can be scheduled back-to-back before a gap is required.

### Aspects Related to Data Transmission in Energy Efficient Scheduling Gap Slots

As discussed above and with reference to FIG. 5, when using energy efficient scheduling, the UE may be scheduled, by the network entity, to receive one or more downlink transmissions in slot 520-a using the second BWP 505-b associated with a relatively wide bandwidth (e.g., wideband operation mode (WB)). The UE may then be configured to perform baseband processing of the one or more downlink transmissions within one or more gap slots that consecutively follow the one or more downlink transmissions.

In some cases, the one or more downlink transmissions may include one or more PDSCHs, which may be scheduled using downlink control information (DCI) transmitted in a PDCCH. Typically, when energy efficient scheduling is used, the UE may be permitted to monitor for DCI transmitted in a PDCCH in the one or more gap slots while the one or more downlink transmissions are processed according to the relaxed or extended minimum processing timeline. However, the DCI information may only be able to schedule the UE to receive a subsequent PDSCH after the baseband processing of the one or more PDSCHs received in slot 520-a has been completed. In other words, when using energy efficient scheduling, the UE may not be scheduled to receive any subsequent downlink transmissions within the one or more gap slots (e.g., as this may, in some cases, cause a receive buffer to overflow, as discussed above).

However, preventing the UE from being scheduled to receive downlink transmissions in the one or more gap slots may lead to resource usage inefficiencies, in some cases. For example, with reference to FIG. 5, there may be some scenarios where a scheduled downlink transmission throughput associated with the slot 520-a (e.g., in which the one or more downlink transmissions are scheduled) is less than the peak data throughput supported by the second BWP 505-b, leaving some unused capacity in the receive buffer of the UE that could have been used by other transmissions. In other words, the one or more downlink transmissions scheduled in slot 520-a may not fully utilize the peak data throughput that is supported by the second BWP 505-b, which may result in time-frequency resources being inefficiently utilized and poor user experience.

Accordingly, aspects of the present disclosure provide techniques for reducing time-frequency resource wastage in scenarios in which, when energy efficient scheduling is being used, a scheduled downlink transmission throughput associated with a slot of a BWP in which one or more downlink transmissions are scheduled is less than a peak data throughput supported by the BWP. For example, in some cases, these techniques may include scheduling one or more subsequent or additional downlink transmissions having a small packet size and relatively low latency within one or more gap slots or gap symbols. Additionally, aspects of the present disclosure provide techniques for avoiding or at least reducing a risk that a receive buffer of a UE is overloaded when the one or more subsequent or additional downlink transmissions are scheduled in the one or more gap slots or gap symbols.

### Example Operations of Entities in a Communications Network

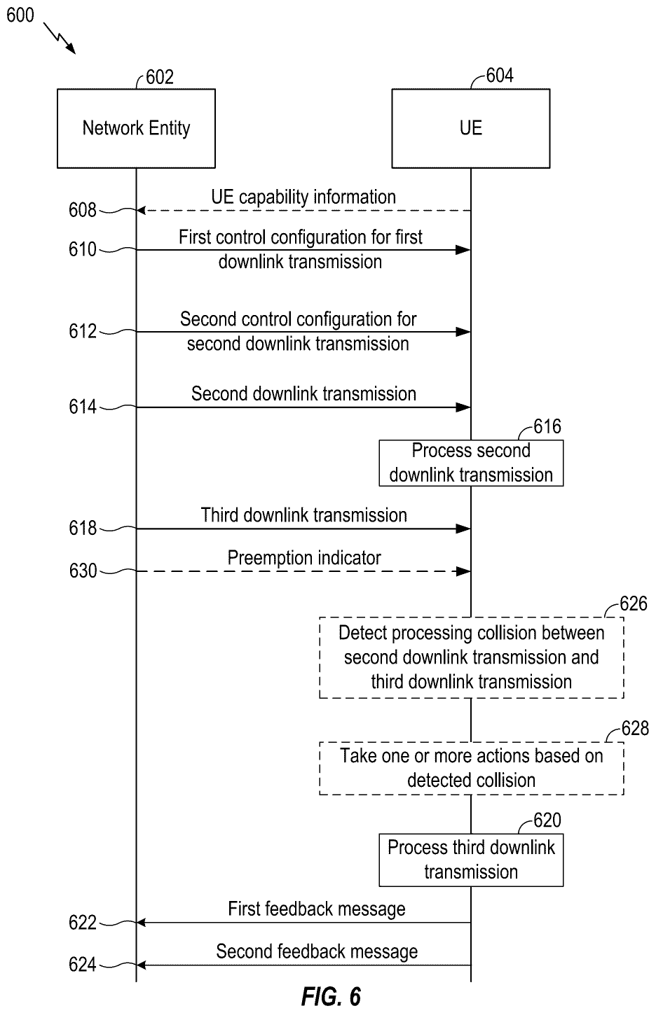

FIG. 6 depicts a process flow including operations 600 for communications in a network between a network entity 602 and a user equipment (UE) 604. In some aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 604 may be another type of wireless communications device and network entity 602 may be another type of network entity or network node, such as those described herein.

As shown, operations 600 begin at 610 with the UE 604 receiving, from the network entity 602, a first control configuration that configures a first peak throughput for at least a first downlink transmission to be received by the UE. In some cases, the configured first peak throughput may be associated with a BWP in which the first downlink transmission is to be received, such as the second BWP 505-b (e.g., a wideband BWP). In some cases, the first control configuration may configure the first peak throughput based on a first set of communication parameters. In some cases, the first set of communication parameters may include one or more parameters associated with Equation 1, such as a bandwidth (e.g., a number of physical resource blocks (PRBs)) associated with the first BWP, a modulation order associated with the first BWP, a rank or number of layers associated with the first BWP, a scaling factor (e.g., Z), an indication of reduce peak throughput mode/limited throughput mode through introducing gaps in time (e.g., some slots, symbols, frames wherein the UE expects no receptions). The configuration or indication of the gaps wherein the UE does not receive any PDSCH may be semi-static (RRC configured, as part of BWP configuration etc.) or may be indicated dynamically through DCI.

At 612, the UE 604 receives a second control configuration from the network entity 602. In some cases, the second control configuration may enable energy efficient scheduling by configuring a second peak throughput, for at least a second downlink transmission to be received by the UE, which is less than the first peak throughput indicated by the first control configuration. In some cases, the configured second peak throughput may be associated with the BWP in which the second downlink transmission is to be received, such as the second BWP 505-b (e.g., a wideband BWP). In some cases, the second control configuration may configure the second peak throughput based on a first set of communication parameters. In some cases, the first control configuration may configure the second peak throughput based on a second set of communication parameters. In some cases, the second set of communication parameters may include one or more parameters associated with Equation 1, such as a bandwidth (e.g., a number of physical resource blocks (PRBs)) associated with the first BWP, a modulation order associated with the first BWP, a rank or number of layers associated with the first BWP, a scaling factor (e.g., Z), etc. In some cases, the second peak throughput may be configured by setting the scaling factor (e.g., Z) to a value greater than one.

In some cases, the second control configuration may relax a processing timeline associated with the second downlink transmission/second BWP. For example, in some cases, the first control configuration may indicate a first processing timeline for processing at least the first downlink transmission. In some cases, the second control configuration may indicate a second processing timeline for processing at least the second downlink transmission that is longer than the first processing timeline.

In some cases, the second control configuration may configure one or more gap slots that consecutively follow the second downlink transmission. In some cases, the one or more gap slots may be configured for processing at least the second downlink transmission.

At 614, the UE 604 may receive, from the network entity 602, at least the second downlink transmission in a first slot in accordance with the second control configuration. In some cases, the second downlink transmission may comprise a wideband PDSCH. Thereafter, as shown at 616, the UE 604 may process the second downlink transmission. In some cases, the UE 604 may process the second downlink transmission during the one or more gap slots according to the second processing timeline.

In some cases, a scheduled downlink transmission throughput associated with the first slot may be less than the second peak throughput. In other words, in some cases, the second downlink transmission may not fully utilize the second peak data throughput, leaving an additional amount of achievable throughput to receive one or more additional downlink transmissions in the one or more gap slots such that the peak throughput is achieved over the period that consists of the scheduled second downlink transmission and the scheduled throughput in the gaps. For example, if the UE is indicated to receive transmission over the first slot and subsequent 3 slots are indicated as gaps (no expected scheduling)—the UE can be scheduled during the 3 slots if the first slot scheduling throughput is less than the peak throughout and the sum of the throughput scheduled in the gaps and the first slot scheduling throughput is smaller or equal to the second peak throughput. For example, as shown at 618, the UE 604 may receive, from the network entity 602, at least a third downlink transmission in the one or more gap slots based on the scheduled downlink transmission throughput associated with the first slot being less than the second peak throughput. In some cases, the third downlink transmission may comprise a low latency PDSCH having a relatively small packet size.

As shown at 620, the UE 604 may then process the third downlink transmission after processing of the second downlink transmission is complete.

Thereafter, as shown at 622, after processing of the second downlink transmission is complete, the UE 604 may transmit a first feedback message for the second downlink transmission. Similarly, at 624, after processing of the third downlink transmission is complete, the UE 604 may transmit a second feedback message for the third downlink transmission.

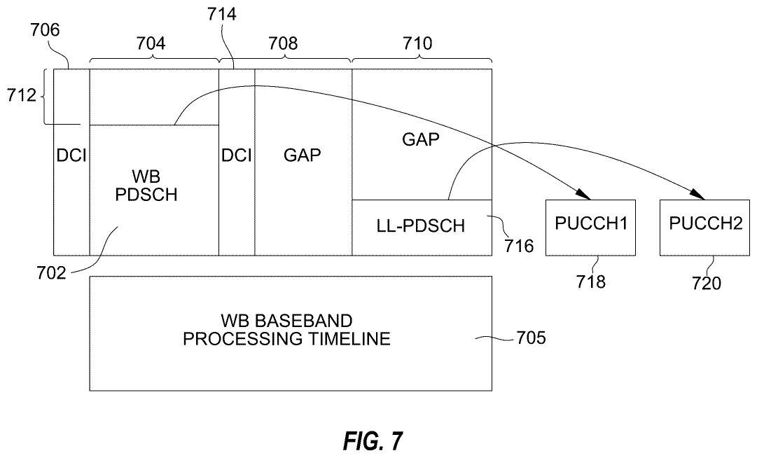

FIG. 7 includes a communications timeline 700 that supports energy efficient scheduling and the scheduling of downlink transmissions in one or more gap slots, as described with reference to FIG. 6.

For example, as shown, the UE 604 may receive the second downlink transmission 702, described able with respect to FIG. 6, in a first slot 704. As shown, the second downlink transmission 702 may be an example of wideband PDSCH. In some cases, the UE 604 may receive a first DCI message that schedules the second downlink transmission 702 in the first slot 704. After receiving the second downlink transmission 702, the UE 604 may begin processing the second downlink transmission 702 according to the second processing timeline 705 described above with respect to FIG. 6. As shown, the UE 604 may be configured to process the second downlink transmission 702 during one or more gap slots, such as a first gap slot 708 and a second gap slot 710.

As noted above, in some cases, a scheduled downlink transmission throughput associated with the first slot 704 may be less than the second peak throughput. For example, in some cases, the second downlink transmission 702 may not fully utilize the second peak data throughput, leaving additional capacity 712 for one or more additional downlink transmissions to be scheduled in one or more gap slots.

For example, as shown, during the processing of the second downlink transmission 702 in the first gap slot 708, the UE 604 may monitor for and receive a second DCI message 714, which may schedule the third downlink transmission 716 in the second gap slot 710. As shown, the third downlink transmission 716 may be an example of a low latency PDSCH having a small packet size capable of being accommodated by the additional capacity 712. In some cases, the additional capacity 712 may represent an amount of extra space available in the receive buffer of the UE 604, beyond what is already used by the second downlink transmission 702, allowing for the reception of further downlink transmissions without overloading the receive buffer. Accordingly, in some cases, the third downlink transmission 716 may be small enough such that, both the second downlink transmission 702 and third downlink transmission 716 may be received and processed by the UE 604 without the receive buffer becoming overloaded.

After processing of the second downlink transmission 702 and the third downlink transmission 716 has been completed, the UE 604 may transmit a first feedback message 718 associated with the second downlink transmission 702 and a second feedback message 720 associated with the third downlink transmission 716.

In some cases, the third downlink transmission may be scheduled and received in the one or more slots when one or more conditions are satisfied. In some cases, the one or more conditions may help to reduce the chances that the receive buffer of the UE 604 becomes overloaded if the third downlink transmission is scheduled and received in the one or more gap slots, which may otherwise cause at least a portion of the second downlink transmission 702 to be overwritten and lost.

In some cases, as shown at 608 in FIG. 6, the UE 604 may optionally transmit UE capability information to the network entity 602 indicating the one or more conditions. In some cases, the UE capability information may indicate to the network entity 602 that the UE 604 is capable of receiving downlink transmissions in the one or more gap slots when the one or more conditions are satisfied.

In some cases, the one or more conditions comprise any one of or a combination of (1) a transport block size (TBS) of the third downlink transmission being equal to or smaller than a threshold TBS, (2) a rank of the third downlink transmission being equal to or below a threshold rank, (3) a modulation and coding scheme (MCS) of the third downlink transmission being equal to or below a threshold MCS, (4) a number of scheduled symbols of the third downlink transmission being equal to or below a threshold number of symbols, or (5) a number of scheduled RBs of the third downlink transmission being equal to or below a threshold number of RBs. In some cases, the UE capability information may explicitly indicate at least one of the threshold TBS, the threshold rank, the threshold MCS, the threshold number of symbols, or the threshold number of RBs.

In some cases, the one or more conditions may include an aggregated bandwidth of the second downlink transmission and the third downlink transmission being equal to or below a maximum bandwidth. For example, if the second downlink transmission is allocated X megahertz (MHz) and the third downlink transmission is allocated Y MHz, the third downlink transmission may be scheduled and received in the one or more gap slots when X MHz+Y MHz is less than or equal to a maximum bandwidth (e.g., Z MHz). In some cases, the bandwidth of the second downlink transmission and the third downlink transmission may be defined in terms of a number of RBs. Similarly, the maximum bandwidth may be defined in terms of the maximum number of RBs.

In some cases, the one or more conditions may include an aggregated rank of the second downlink transmission and the third downlink transmission being equal to or below a maximum rank. For example, if the second downlink transmission is allocated rank 1 and the third downlink transmission is allocated rank 2, the third downlink transmission may be scheduled and received in the one or more gap slots when rank 1+rank 2 is less than or equal to the maximum rank.

In some cases, the one or more conditions may include an aggregated number of symbols of the second downlink transmission and the third downlink transmission being equal to or below a maximum number of symbols. For example, if the second downlink transmission is allocated a first number of symbols and the third downlink transmission is allocated second number of symbols, the third downlink transmission may be scheduled and received in the one or more gap slots when the first number of symbols+the second number of symbols is less than or equal to the maximum number of symbols.

In some cases, the one or more conditions may include an MCS of the second downlink transmission and an MCS of the third downlink transmission both being below respective maximum MCSs. For example, if an MCS of the second downlink transmission is less than a first maximum MCS and an MCS of the third downlink transmission is less than a second maximum MCS, the third downlink transmission may be scheduled and received in the one or more gap slots.

In some cases, the one or more conditions may include an aggregated throughput of the second downlink transmission and the third downlink transmission being less than or equal to the second peak throughput. For example, if the second downlink transmission has a first throughput (e.g., X megabits per second (Mbps)) and the third downlink transmission has a second throughput (e.g., Y Mbps), the third downlink transmission may be scheduled and received in the one or more gap slots when X Mbps+Y Mbps is less than or equal to the second peak throughput. In some cases, the throughput of the second downlink transmission and the throughput of the third downlink transmission may be determined using Equation 1, above.

In some cases, while the second downlink transmission and the third downlink transmission may be transmitted in different slots and, thus, their scheduled time-frequency resources may not conflict with each other (e.g., overlap or collide), a conflict between the second downlink transmission and third downlink transmission may nevertheless occur due to baseband processing of the second downlink transmission not being complete by the time the UE 604 has to transmit feedback information for the third downlink transmission.

For example, as shown at 626 in FIG. 6, the UE 604 may optionally detect a conflict between a processing timeline of the second downlink transmission and a processing timeline of the third downlink transmission. In response, at 628, the UE 604 may optionally take one or more actions based on the detected conflict, for example, to resolve the detected conflict.

In some cases, when a size of a receive buffer of the UE 604 is unable to accommodate the second downlink transmission and the third downlink transmission simultaneously, taking the one or more actions at 628 may include dropping the second downlink transmission and, based on dropping the second downlink transmission, processing the third downlink transmission during the one or more gap slots, as shown at 620. In some cases, dropping the second downlink transmission comprises flushing the receive buffer of the UE 604 in which the second downlink transmission is stored for processing.

In some cases, when the size of receive buffer of the UE is able to accommodate the second downlink transmission and the third downlink transmission simultaneously, taking the one or more actions at 628 may include processing the second downlink transmission (e.g., as shown at 616) and processing the third downlink transmission after finishing processing the second downlink transmission (e.g., as shown at 620). The UE 604 may then transmit the first feedback message and the second feedback message at 622 and 624, respectively, after processing the second downlink message and the third downlink message.

In some cases, the UE 604 may be configured to drop the second downlink transmission regardless of the size of the receive buffer of the UE when the conflict is detected. For example, in some cases, taking the one or more actions at 628 may include, regardless of the size of the receive buffer of the UE 604, dropping the second downlink transmission and, based on dropping the second downlink transmission, processing the third downlink transmission during the one or more gap slots.

In some cases, taking the one or more actions at 628 may be based on additional information regarding the third downlink transmission received from the network entity 602. For example, as shown at 630 in FIG. 6, the UE 604 may receive, from the network entity 602, a message including a preemption indicator associated with the third downlink transmission. In some cases, the preemption indicator may indicate that processing of the third downlink transmission preempts processing of the second downlink transmission. In such cases, taking the one or more actions at 628 may include dropping the second downlink transmission based on the preemption indicator associated with the third downlink transmission and, based on dropping the second downlink transmission, processing the third downlink transmission during the one or more gap slots. In some cases, a preemption indictor may not be necessary. For example, if the network entity has scheduled the UE 604 during the one or more gap slots, this can be seen as exception case for low latency traffic, such as the third downlink transmission. As such, in this case, the processing of the third downlink transmission may always be prioritized over the second downlink transmission (e.g., the second downlink transmission is dropped and the third downlink transmission is processed).

As noted above, in some cases, the second control configuration received by the UE 604 at 612 in FIG. 6 may indicate a second processing timeline for processing at least the second downlink transmission that is longer than the first processing timeline configured by the first control configuration. In other words, the second processing timeline is relaxed relative to the first processing timeline. In some cases, a third processing timeline for processing the third downlink transmission may shorter than the second processing timeline indicated in the second control configuration. For example, in some cases, the third processing timeline may be the same as the (non-relaxed) first processing timeline (e.g., an N1 default processing timeline without energy efficient scheduling).

Based on the third processing timeline being shorter than the second processing timeline indicated in the second control configuration, the UE 604 may not expect to be scheduled or to receive and process the third downlink transmission in a power saving BWP according to the (shorter) third processing timeline unless the network entity 602 guarantees at least one of (1) a TBS of the third downlink transmission is less than a threshold TBS, (2) a rank of the third downlink transmission is less than a threshold rank, (3) an MCS of the third downlink transmission is less than a threshold MCS, (4) a number of scheduled symbols of the third downlink transmission being below a threshold number of symbols, or (5) a number of scheduled resource blocks (RBs) of the third downlink transmission being below a threshold number of RBs.

### Example Operations of a User Equipment

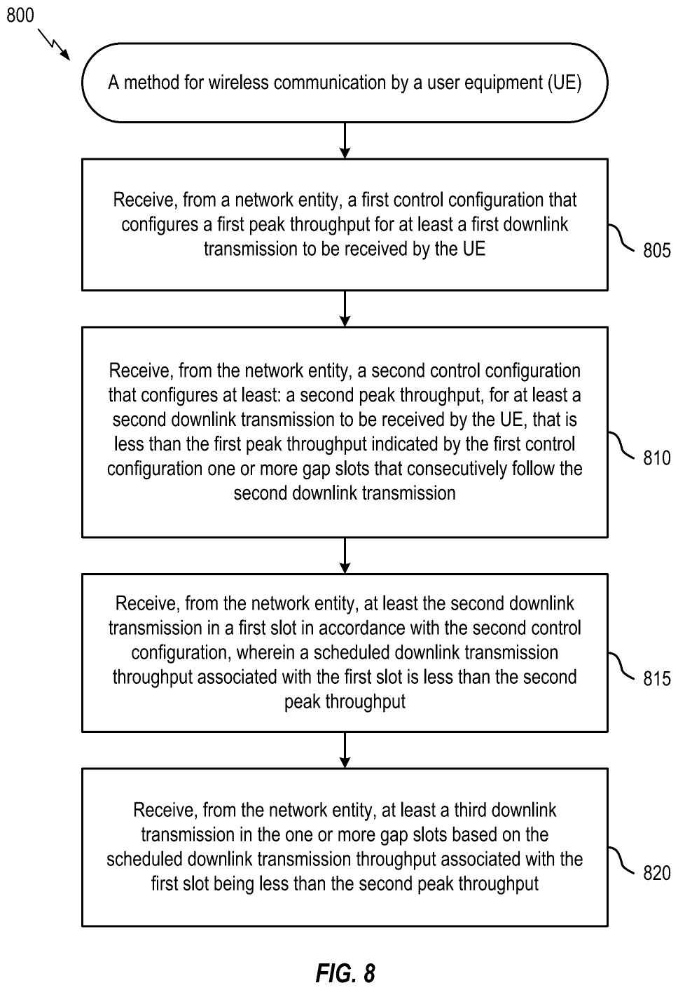

FIG. 8 shows an example of a method 800 of wireless communication by a user equipment (UE), such as a UE 104 of FIGS. 1 and 3.

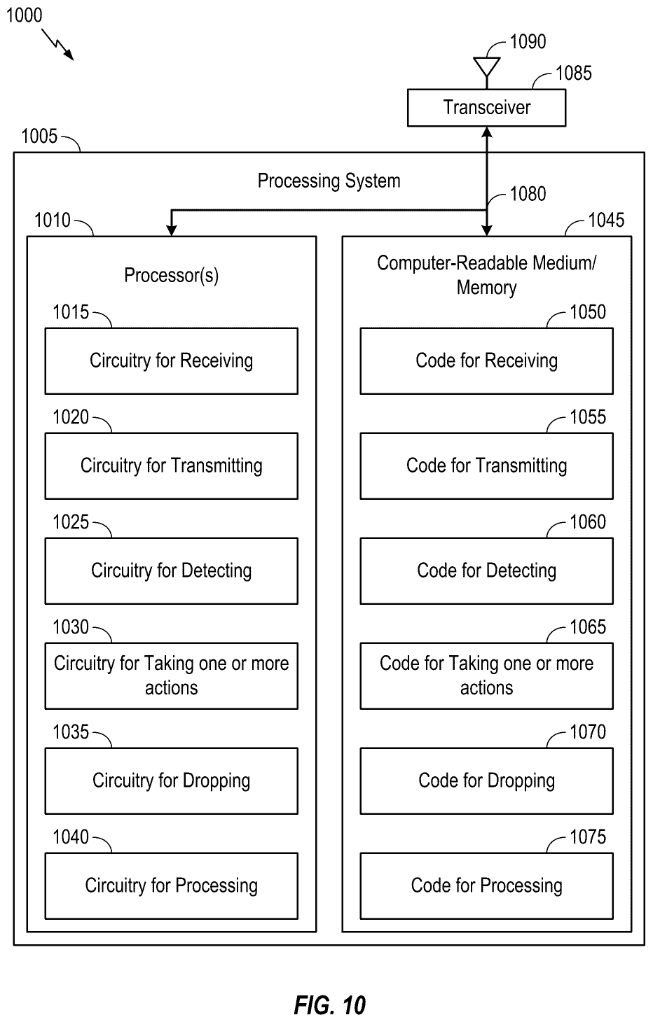

Method 800 begins at step 805 with receiving, from a network entity, a first control configuration that configures a first peak throughput for at least a first downlink transmission to be received by the UE. In some cases, the operations of this step refer to, or may be performed by, circuitry for receiving and/or code for receiving as described with reference to FIG. 10.

Method 800 then proceeds to step 810 with receiving, from the network entity, a second control configuration that configures at least: a second peak throughput, for at least a second downlink transmission to be received by the UE, that is less than the first peak throughput indicated by the first control configuration one or more gap slots that consecutively follow the second downlink transmission. In some cases, the operations of this step refer to, or may be performed by, circuitry for receiving and/or code for receiving as described with reference to FIG. 10.

Method 800 then proceeds to step 815 with receiving, from the network entity, at least the second downlink transmission in a first slot in accordance with the second control configuration, wherein a scheduled downlink transmission throughput associated with the first slot is less than the second peak throughput. In some cases, the operations of this step refer to, or may be performed by, circuitry for receiving and/or code for receiving as described with reference to FIG. 10.

Method 800 then proceeds to step 820 with receiving, from the network entity, at least a third downlink transmission in the one or more gap slots based on the scheduled downlink transmission throughput associated with the first slot being less than the second peak throughput. In some cases, the operations of this step refer to, or may be performed by, circuitry for receiving and/or code for receiving as described with reference to FIG. 10.

In some aspects, the one or more gap slots are configured for processing at least the second downlink transmission.

In some aspects, the first control configuration indicates a first processing timeline for processing at least the first downlink transmission; and the second control configuration indicates a second processing timeline for processing at least the second downlink transmission that is longer than the first processing timeline.

In some aspects, a third processing timeline for processing the third downlink transmission is shorter than the second processing timeline indicated in the second control configuration.

In some aspects, based on the third processing timeline being shorter than the second processing timeline indicated in the second control configuration, at least one of: a transport block size (TBS) of the third downlink transmission is less than a threshold TBS; a rank of the third downlink transmission is less than a threshold rank; a modulation an coding scheme (MCS) of the third downlink transmission is less than a threshold MCS; a number of scheduled symbols of the third downlink transmission being below a threshold number of symbols; or a number of scheduled resource blocks (RBs) of the third downlink transmission being below a threshold number of RBs.

In some aspects, at least the third downlink transmission is received when one or more conditions are satisfied.

In some aspects, the one or more conditions comprise a transport block size (TBS) of the third downlink transmission being smaller than a threshold TBS.

In some aspects, the method 800 further includes transmitting, to the network entity, an indication of the threshold TBS. In some cases, the operations of this step refer to, or may be performed by, circuitry for transmitting and/or code for transmitting as described with reference to FIG. 10.

In some aspects, the one or more conditions comprise at least one of: a rank of the third downlink transmission being below a threshold rank; a modulation and coding scheme (MCS) of the third downlink transmission being below a threshold MCS; a number of scheduled symbols of the third downlink transmission being below a threshold number of symbols; or a number of scheduled resource blocks (RBs) of the third downlink transmission being below a threshold number of RBs.

In some aspects, the one or more conditions comprise at least one of: an aggregated bandwidth of the second downlink transmission and the third downlink transmission being equal to or below a maximum bandwidth; an aggregated rank of the second downlink transmission and the third downlink transmission being equal to or below a maximum rank; an aggregated number of symbols of the second downlink transmission and the third downlink transmission being equal to or below a maximum number of symbols; an MCS of the second downlink transmission and an MCS of the third downlink transmission both being below respective maximum MCSs; or an aggregated throughput of the second downlink transmission and the third downlink transmission being less than or equal to the second peak throughput.

In some aspects, the method 800 further includes detecting a conflict between a processing timeline of the second downlink transmission and a processing timeline of the third downlink transmission. In some cases, the operations of this step refer to, or may be performed by, circuitry for detecting and/or code for detecting as described with reference to FIG. 10.

In some aspects, the method 800 further includes taking one or more actions based on the detected conflict. In some cases, the operations of this step refer to, or may be performed by, circuitry for taking one or more actions and/or code for taking one or more actions as described with reference to FIG. 10.

In some aspects, when a size of a buffer of the UE is unable to accommodate the second downlink transmission and the third downlink transmission simultaneously, taking the one or more actions comprises: dropping the second downlink transmission; and.

In some aspects, dropping the second downlink transmission comprises flushing the buffer of the UE in which the second downlink transmission is stored for processing.

In some aspects, when the size of the buffer of the UE is able to accommodate the second downlink transmission and the third downlink transmission simultaneously, taking the one or more actions comprises: processing the second downlink transmission; and processing the third downlink transmission after finishing processing the second downlink transmission.

In some aspects, regardless of the size of the buffer of the UE, taking the one or more actions comprises: dropping the second downlink transmission; and based on dropping the second downlink transmission, processing the third downlink transmission during the one or more gap slots.

In some aspects, the method 800 further includes receiving a message including a preemption indicator associated with the third downlink transmission, wherein the preemption indicator indicates that processing of the third downlink transmission preempts processing of the second downlink transmission. In some cases, the operations of this step refer to, or may be performed by, circuitry for receiving and/or code for receiving as described with reference to FIG. 10.

In some aspects, taking the one or more actions comprises: dropping the second downlink transmission based on the preemption indicator associated with the third downlink transmission; and based on dropping the second downlink transmission, processing the third downlink transmission during the one or more gap slots.

In some aspects, the first peak throughput is based on a first set of communication parameters for transmission of at least the first downlink transmission; and the second peak throughput is based on a second set of communication parameters for transmission of at least the second downlink transmission.

In some aspects, the second peak throughput is less than the first peak throughput based on a scaling factor included within the second set of transmission parameters.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Operations of a Network Entity

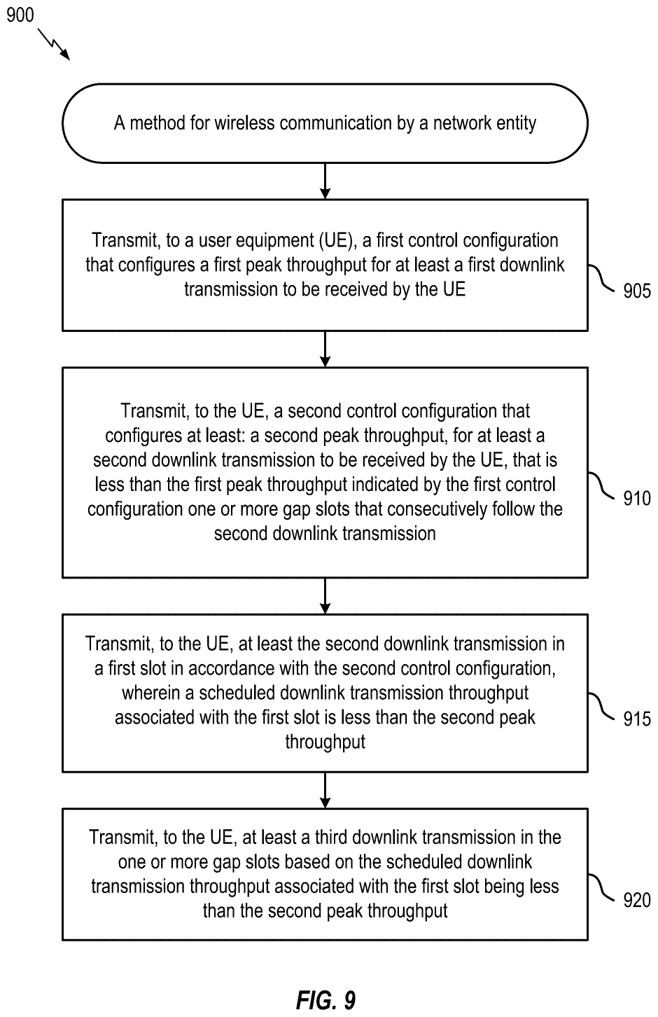

FIG. 9 shows an example of a method 900 of wireless communication by a network entity, such as a BS 102 of FIGS. 1 and 3, or a disaggregated base station as discussed with respect to FIG. 2.

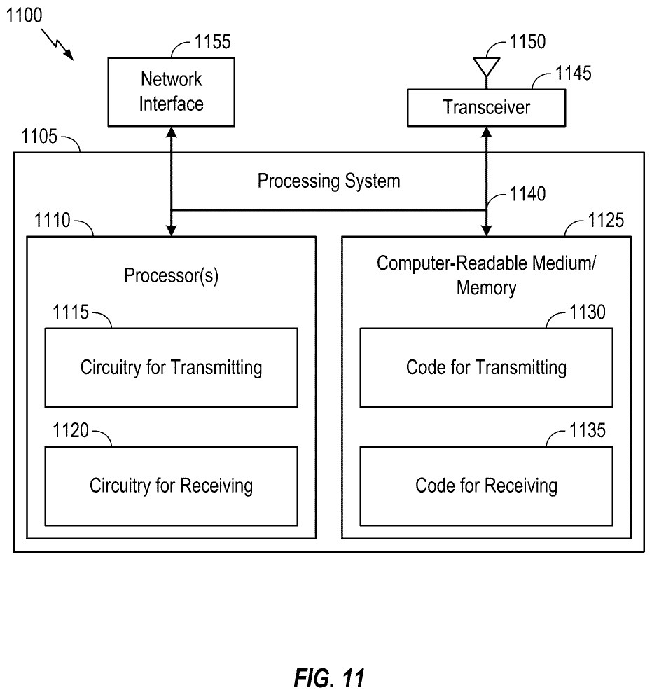

Method 900 begins at step 905 with transmitting, to a user equipment (UE), a first control configuration that configures a first peak throughput for at least a first downlink transmission to be received by the UE. In some cases, the operations of this step refer to, or may be performed by, circuitry for transmitting and/or code for transmitting as described with reference to FIG. 11.

Method 900 then proceeds to step 910 with transmitting, to the UE, a second control configuration that configures at least: a second peak throughput, for at least a second downlink transmission to be received by the UE, that is less than the first peak throughput indicated by the first control configuration one or more gap slots that consecutively follow the second downlink transmission. In some cases, the operations of this step refer to, or may be performed by, circuitry for transmitting and/or code for transmitting as described with reference to FIG. 11.

Method 900 then proceeds to step 915 with transmitting, to the UE, at least the second downlink transmission in a first slot in accordance with the second control configuration, wherein a scheduled downlink transmission throughput associated with the first slot is less than the second peak throughput. In some cases, the operations of this step refer to, or may be performed by, circuitry for transmitting and/or code for transmitting as described with reference to FIG. 11.

Method 900 then proceeds to step 920 with transmitting, to the UE, at least a third downlink transmission in the one or more gap slots based on the scheduled downlink transmission throughput associated with the first slot being less than the second peak throughput. In some cases, the operations of this step refer to, or may be performed by, circuitry for transmitting and/or code for transmitting as described with reference to FIG. 11.

In some aspects, the one or more gap slots are configured for the UE to process at least the second downlink transmission.

In some aspects, the first control configuration indicates a first processing timeline for processing at least the first downlink transmission; and the second control configuration indicates a second processing timeline for processing at least the second downlink transmission that is longer than the first processing timeline.

In some aspects, a third processing timeline for processing the third downlink transmission is shorter than the second processing timeline indicated in the second control configuration.

In some aspects, based on the third processing timeline being shorter than the second processing timeline indicated in the second control configuration, at least one of: a transport block size (TBS) of the third downlink transmission is less than a threshold TBS; a rank of the third downlink transmission is less than a threshold rank; a modulation an coding scheme (MCS) of the third downlink transmission is less than a threshold MCS; a number of scheduled symbols of the third downlink transmission being below a threshold number of symbols; or a number of scheduled resource blocks (RBs) of the third downlink transmission being below a threshold number of RBs.

In some aspects, at least the third downlink transmission is transmitted when one or more conditions are satisfied.

In some aspects, the one or more conditions comprise a transport block size (TBS) of the third downlink transmission being smaller than a threshold TBS.

In some aspects, the method 900 further includes receiving, from the UE, an indication of the threshold TBS. In some cases, the operations of this step refer to, or may be performed by, circuitry for receiving and/or code for receiving as described with reference to FIG. 11.

In some aspects, the one or more conditions comprise at least one of: a rank of the third downlink transmission being below a threshold rank; a modulation and coding scheme (MCS) of the third downlink transmission being below a threshold MCS; a number of scheduled symbols of the third downlink transmission being below a threshold number of symbols; or a number of scheduled resource blocks (RBs) of the third downlink transmission being below a threshold number of RBs.

In some aspects, the one or more conditions comprise at least one of: an aggregated bandwidth of the second downlink transmission and the third downlink transmission being equal to or below a maximum bandwidth; an aggregated rank of the second downlink transmission and the third downlink transmission being equal to or below a maximum rank; an aggregated number of symbols of the second downlink transmission and the third downlink transmission being equal to or below a maximum number of symbols; an MCS of the second downlink transmission and an MCS of the third downlink transmission both being below respective maximum MCSs; or an aggregated throughput of the second downlink transmission and the third downlink transmission being less than or equal to the second peak throughput.

In some aspects, the method 900 further includes transmitting a message including a preemption indicator associated with the third downlink transmission, wherein the preemption indicator indicates that processing of the third downlink transmission preempts processing of the second downlink transmission. In some cases, the operations of this step refer to, or may be performed by, circuitry for transmitting and/or code for transmitting as described with reference to FIG. 11.

In some aspects, the first peak throughput is based on a first set of communication parameters for transmission of at least the first downlink transmission; and the second peak throughput is based on a second set of communication parameters for transmission of at least the second downlink transmission.

In some aspects, the second peak throughput is less than the first peak throughput based on a scaling factor included within the second set of transmission parameters.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Communications Device(s)

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to the transceiver 1085 (e.g., a transmitter and/or a receiver). The transceiver 1085 is configured to transmit and receive signals for the communications device 1000 via the antenna 1090, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1045 via a bus 1080. In certain aspects, the computer-readable medium/memory 1045 is configured to store instructions (e.g., computer-executable code) that when executed by the one or more processors 1010, cause the one or more processors 1010 to perform the method 800 described with respect to FIG. 8, or any aspect related to it. Note that reference to a processor performing a function of communications device 1000 may include one or more processors 1010 performing that function of communications device 1000.

In the depicted example, computer-readable medium/memory 1045 stores code (e.g., executable instructions), such as code for receiving 1050, code for transmitting 1055, code for detecting 1060, code for taking one or more actions 1065, code for dropping 1070, and code for processing 1075. Processing of the code for receiving 1050, code for transmitting 1055, code for detecting 1060, code for taking one or more actions 1065, code for dropping 1070, and code for processing 1075 may cause the communications device 1000 to perform the method 800 described with respect to FIG. 8, or any aspect related to it.

The one or more processors 1010 include circuitry configured to implement (e.g., execute) the code stored in the computer-readable medium/memory 1045, including circuitry such as circuitry for receiving 1015, circuitry for transmitting 1020, circuitry for detecting 1025, circuitry for taking one or more actions 1030, circuitry for dropping 1035, and circuitry for processing 1040. Processing with circuitry for receiving 1015, circuitry for transmitting 1020, circuitry for detecting 1025, circuitry for taking one or more actions 1030, circuitry for dropping 1035, and circuitry for processing 1040 may cause the communications device 1000 to perform the method 800 described with respect to FIG. 8, or any aspect related to it.

Various components of the communications device 1000 may provide means for performing the method 800 described with respect to FIG. 8, or any aspect related to it. For example, means for transmitting, sending or outputting for transmission may include transceivers 354 and/or antenna(s) 352 of the UE 104 illustrated in FIG. 3 and/or the transceiver 1085 and the antenna 1090 of the communications device 1000 in FIG. 10. Means for receiving or obtaining may include transceivers 354 and/or antenna(s) 352 of the UE 104 illustrated in FIG. 3 and/or the transceiver 1085 and the antenna 1090 of the communications device 1000 in FIG. 10.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to the transceiver 1145 (e.g., a transmitter and/or a receiver) and/or a network interface 1155. The transceiver 1145 is configured to transmit and receive signals for the communications device 1100 via the antenna 1150, such as the various signals as described herein. The network interface 1155 is configured to obtain and send signals for the communications device 1100 via communication link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code) that when executed by the one or more processors 1110, cause the one or more processors 1110 to perform the method 900 described with respect to FIG. 9, or any aspect related to it. Note that reference to a processor of communications device 1100 performing a function may include one or more processors 1110 of communications device 1100 performing that function.

In the depicted example, the computer-readable medium/memory 1125 stores code (e.g., executable instructions), such as code for transmitting 1130 and code for receiving 1135. Processing of the code for transmitting 1130 and code for receiving 1135 may cause the communications device 1100 to perform the method 900 described with respect to FIG. 9, or any aspect related to it.

The one or more processors 1110 include circuitry configured to implement (e.g., execute) the code stored in the computer-readable medium/memory 1125, including circuitry such as circuitry for transmitting 1115 and circuitry for receiving 1120. Processing with circuitry for transmitting 1115 and circuitry for receiving 1120 may cause the communications device 1100 to perform the method 900 described with respect to FIG. 9, or any aspect related to it.

Various components of the communications device 1100 may provide means for performing the method 900 described with respect to FIG. 9, or any aspect related to it. Means for transmitting, sending or outputting for transmission may include transceivers 332 and/or antenna(s) 334 of the BS 102 illustrated in FIG. 3 and/or the transceiver 1145 and the antenna 1150 of the communications device 1100 in FIG. 11. Means for receiving or obtaining may include transceivers 332 and/or antenna(s) 334 of the BS 102 illustrated in FIG. 3 and/or the transceiver 1145 and the antenna 1150 of the communications device 1100 in FIG. 11.

### Example Clauses

Implementation examples are described in the following numbered clauses:

Clause 1: A method for wireless communication by a user equipment (UE), comprising: receiving, from a network entity, a first control configuration that configures a first peak throughput for at least a first downlink transmission to be received by the UE; receiving, from the network entity, a second control configuration that configures at least: a second peak throughput, for at least a second downlink transmission to be received by the UE, that is less than the first peak throughput indicated by the first control configuration one or more gap slots that consecutively follow the second downlink transmission; receiving, from the network entity, at least the second downlink transmission in a first slot in accordance with the second control configuration, wherein a scheduled downlink transmission throughput associated with the first slot is less than the second peak throughput; and receiving, from the network entity, at least a third downlink transmission in the one or more gap slots based on the scheduled downlink transmission throughput associated with the first slot being less than the second peak throughput.

Clause 2: The method of Clause 1, wherein the one or more gap slots are configured for processing at least the second downlink transmission.

Clause 3: The method of any one of Clauses 1-2, wherein: the first control configuration indicates a first processing timeline for processing at least the first downlink transmission; and the second control configuration indicates a second processing timeline for processing at least the second downlink transmission that is longer than the first processing timeline.

Clause 4: The method of Clause 3, wherein a third processing timeline for processing the third downlink transmission is shorter than the second processing timeline indicated in the second control configuration.

Clause 5: The method of Clause 4, wherein, based on the third processing timeline being shorter than the second processing timeline indicated in the second control configuration, at least one of: a transport block size (TBS) of the third downlink transmission is less than a threshold TBS; a rank of the third downlink transmission is less than a threshold rank; a modulation an coding scheme (MCS) of the third downlink transmission is less than a threshold MCS; a number of scheduled symbols of the third downlink transmission being below a threshold number of symbols; or a number of scheduled resource blocks (RBs) of the third downlink transmission being below a threshold number of RBs.

Clause 6: The method of any one of Clauses 1-5, wherein at least the third downlink transmission is received when one or more conditions are satisfied.

Clause 7: The method of Clause 6, wherein the one or more conditions comprise a transport block size (TBS) of the third downlink transmission being smaller than a threshold TBS.

Clause 8: The method of Clause 7, further comprising transmitting, to the network entity, an indication of the threshold TBS.

Clause 9: The method of Clause 6, wherein the one or more conditions comprise at least one of: a rank of the third downlink transmission being below a threshold rank; a modulation and coding scheme (MCS) of the third downlink transmission being below a threshold MCS; a number of scheduled symbols of the third downlink transmission being below a threshold number of symbols; or a number of scheduled resource blocks (RBs) of the third downlink transmission being below a threshold number of RBs.

Clause 10: The method of Clause 6, wherein the one or more conditions comprise at least one of: an aggregated bandwidth of the second downlink transmission and the third downlink transmission being equal to or below a maximum bandwidth; an aggregated rank of the second downlink transmission and the third downlink transmission being equal to or below a maximum rank; an aggregated number of symbols of the second downlink transmission and the third downlink transmission being equal to or below a maximum number of symbols; an MCS of the second downlink transmission and an MCS of the third downlink transmission both being below respective maximum MCSs; or an aggregated throughput of the second downlink transmission and the third downlink transmission being less than or equal to the second peak throughput.

Clause 11: The method of any one of Clauses 1-10, further comprising: detecting a conflict between a processing timeline of the second downlink transmission and a processing timeline of the third downlink transmission; and taking one or more actions based on the detected conflict.

Clause 12: The method of Clause 11, wherein, when a size of a buffer of the UE is unable to accommodate the second downlink transmission and the third downlink transmission simultaneously, taking the one or more actions comprises: dropping the second downlink transmission; and

Clause 13: The method of Clause 12, wherein dropping the second downlink transmission comprises flushing the buffer of the UE in which the second downlink transmission is stored for processing.

Clause 14: The method of Clause 12, wherein, when the size of the buffer of the UE is able to accommodate the second downlink transmission and the third downlink transmission simultaneously, taking the one or more actions comprises: processing the second downlink transmission; and processing the third downlink transmission after finishing processing the second downlink transmission.

Clause 15: The method of Clause 12, wherein, regardless of the size of the buffer of the UE, taking the one or more actions comprises: dropping the second downlink transmission; and based on dropping the second downlink transmission, processing the third downlink transmission during the one or more gap slots.

Clause 16: The method of Clause 12, further comprising receiving a message including a preemption indicator associated with the third downlink transmission, wherein the preemption indicator indicates that processing of the third downlink transmission preempts processing of the second downlink transmission.

Clause 17: The method of Clause 16, wherein taking the one or more actions comprises: dropping the second downlink transmission based on the preemption indicator associated with the third downlink transmission; and based on dropping the second downlink transmission, processing the third downlink transmission during the one or more gap slots.

Clause 18: The method of any one of Clauses 1-17, wherein: the first peak throughput is based on a first set of communication parameters for transmission of at least the first downlink transmission; and the second peak throughput is based on a second set of communication parameters for transmission of at least the second downlink transmission.

Clause 19: The method of Clause 18, wherein the second peak throughput is less than the first peak throughput based on a scaling factor included within the second set of transmission parameters.

Clause 20: A method for wireless communication by a network entity, comprising: transmitting, to a user equipment (UE), a first control configuration that configures a first peak throughput for at least a first downlink transmission to be received by the UE; transmitting, to the UE, a second control configuration that configures at least: a second peak throughput, for at least a second downlink transmission to be received by the UE, that is less than the first peak throughput indicated by the first control configuration one or more gap slots that consecutively follow the second downlink transmission; transmitting, to the UE, at least the second downlink transmission in a first slot in accordance with the second control configuration, wherein a scheduled downlink transmission throughput associated with the first slot is less than the second peak throughput; and transmitting, to the UE, at least a third downlink transmission in the one or more gap slots based on the scheduled downlink transmission throughput associated with the first slot being less than the second peak throughput.

Clause 21: The method of Clause 20, wherein the one or more gap slots are configured for the UE to process at least the second downlink transmission.

Clause 22: The method of any one of Clauses 20-21, wherein: the first control configuration indicates a first processing timeline for processing at least the first downlink transmission; and the second control configuration indicates a second processing timeline for processing at least the second downlink transmission that is longer than the first processing timeline.

Clause 23: The method of Clause 22, wherein a third processing timeline for processing the third downlink transmission is shorter than the second processing timeline indicated in the second control configuration.

Clause 24: The method of Clause 23, wherein, based on the third processing timeline being shorter than the second processing timeline indicated in the second control configuration, at least one of: a transport block size (TBS) of the third downlink transmission is less than a threshold TBS; a rank of the third downlink transmission is less than a threshold rank; a modulation an coding scheme (MCS) of the third downlink transmission is less than a threshold MCS; a number of scheduled symbols of the third downlink transmission being below a threshold number of symbols; or a number of scheduled resource blocks (RBs) of the third downlink transmission being below a threshold number of RBs.

Clause 25: The method of any one of Clauses 20-24, wherein at least the third downlink transmission is transmitted when one or more conditions are satisfied.

Clause 26: The method of Clause 25, wherein the one or more conditions comprise a transport block size (TBS) of the third downlink transmission being smaller than a threshold TBS.

Clause 27: The method of Clause 26, further comprising receiving, from the UE, an indication of the threshold TBS.

Clause 28: The method of Clause 25, wherein the one or more conditions comprise at least one of: a rank of the third downlink transmission being below a threshold rank; a modulation and coding scheme (MCS) of the third downlink transmission being below a threshold MCS; a number of scheduled symbols of the third downlink transmission being below a threshold number of symbols; or a number of scheduled resource blocks (RBs) of the third downlink transmission being below a threshold number of RBs.

Clause 29: The method of Clause 25, wherein the one or more conditions comprise at least one of: an aggregated bandwidth of the second downlink transmission and the third downlink transmission being equal to or below a maximum bandwidth; an aggregated rank of the second downlink transmission and the third downlink transmission being equal to or below a maximum rank; an aggregated number of symbols of the second downlink transmission and the third downlink transmission being equal to or below a maximum number of symbols; an MCS of the second downlink transmission and an MCS of the third downlink transmission both being below respective maximum MCSs; or an aggregated throughput of the second downlink transmission and the third downlink transmission being less than or equal to the second peak throughput.

Clause 30: The method of any one of Clauses 20-29, further comprising transmitting a message including a preemption indicator associated with the third downlink transmission, wherein the preemption indicator indicates that processing of the third downlink transmission preempts processing of the second downlink transmission.

Clause 31: The method of any one of Clauses 20-30, wherein: the first peak throughput is based on a first set of communication parameters for transmission of at least the first downlink transmission; and the second peak throughput is based on a second set of communication parameters for transmission of at least the second downlink transmission.

Clause 32: The method of Clause 31, wherein the second peak throughput is less than the first peak throughput based on a scaling factor included within the second set of transmission parameters.

Clause 33: An apparatus, comprising: at least one memory comprising executable instructions; and at least one processor configured to execute the executable instructions and cause the apparatus to perform a method in accordance with any combination of Clauses 1-32.

Clause 34: An apparatus, comprising means for performing a method in accordance with any combination of Clauses 1-32.

Clause 35: A non-transitory computer-readable medium comprising executable instructions that, when executed by at least one processor of an apparatus, cause the apparatus to perform a method in accordance with any combination of Clauses 1-32.

Clause 36: A computer program product embodied on a computer-readable storage medium comprising code for performing a method in accordance with any combination of Clauses 1-32.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE), comprising:
one or more processors configured to execute instructions stored on one or more memories and to cause the UE to:
receive, from a network entity, a first control configuration that configures a first peak throughput for at least a first downlink transmission to be received by the UE;
receive, from the network entity, a second control configuration that configures at least:
a second peak throughput, for at least a second downlink transmission to be received by the UE, that is less than the first peak throughput indicated by the first control configuration; and
one or more gap slots that consecutively follow the second downlink transmission;
receive, from the network entity, at least the second downlink transmission in a first slot in accordance with the second control configuration, wherein a scheduled downlink transmission throughput associated with the first slot is less than the second peak throughput; and
receive, from the network entity, at least a third downlink transmission in the one or more gap slots based on the scheduled downlink transmission throughput associated with the first slot being less than the second peak throughput.

2. The UE of claim 1, wherein the one or more gap slots are configured for processing at least the second downlink transmission.

3. The UE of claim 1, wherein:
the first control configuration indicates a first processing timeline for processing at least the first downlink transmission; and
the second control configuration indicates a second processing timeline for processing at least the second downlink transmission that is longer than the first processing timeline.

4. The UE of claim 3, wherein a third processing timeline for processing the third downlink transmission is shorter than the second processing timeline indicated in the second control configuration.

5. The UE of claim 4, wherein, based on the third processing timeline being shorter than the second processing timeline indicated in the second control configuration, at least one of:
a transport block size (TBS) of the third downlink transmission is less than a threshold TBS;
a rank of the third downlink transmission is less than a threshold rank;
a modulation an coding scheme (MCS) of the third downlink transmission is less than a threshold MCS;
a number of scheduled symbols of the third downlink transmission being below a threshold number of symbols; or
a number of scheduled resource blocks (RBs) of the third downlink transmission being below a threshold number of RBs.

6. The UE of claim 1, wherein at least the third downlink transmission is received when one or more conditions are satisfied.

7. The UE of claim 6, wherein the one or more conditions comprise a transport block size (TBS) of the third downlink transmission being smaller than a threshold TBS.

8. The UE of claim 7, wherein the one or more processors are further configured to cause the UE to transmit, to the network entity, an indication of the threshold TBS.

9. The UE of claim 6, wherein the one or more conditions comprise at least one of:
a rank of the third downlink transmission being below a threshold rank;
a modulation and coding scheme (MCS) of the third downlink transmission being below a threshold MCS;
a number of scheduled symbols of the third downlink transmission being below a threshold number of symbols; or
a number of scheduled resource blocks (RBs) of the third downlink transmission being below a threshold number of RBs.

10. The UE of claim 6, wherein the one or more conditions comprise at least one of:
an aggregated bandwidth of the second downlink transmission and the third downlink transmission being equal to or below a maximum bandwidth;
an aggregated rank of the second downlink transmission and the third downlink transmission being equal to or below a maximum rank;
an aggregated number of symbols of the second downlink transmission and the third downlink transmission being equal to or below a maximum number of symbols;
an MCS of the second downlink transmission and an MCS of the third downlink transmission both being below respective maximum MCSs; or
an aggregated throughput of the second downlink transmission and the third downlink transmission being less than or equal to the second peak throughput.

11. The UE of claim 1, wherein the one or more processors are further configured to cause the UE to:
detect a conflict between a processing timeline of the second downlink transmission and a processing timeline of the third downlink transmission; and
take one or more actions based on the detected conflict.

12. The UE of claim 11, wherein, in order to take the one or more actions when a size of a buffer of the UE is unable to accommodate the second downlink transmission and the third downlink transmission simultaneously, the one or more processors are configured to cause the UE to:
drop the second downlink transmission; and
based on dropping the second downlink transmission, process the third downlink transmission during the one or more gap slots.

13. The UE of claim 12, wherein, in order to drop the second downlink transmission, the one or more processors are configured to cause the UE to flush buffer of the UE in which the second downlink transmission is stored for processing.

14. The UE of claim 12, wherein, in order to take the one or more actions when the size of the buffer of the UE is able to accommodate the second downlink transmission and the third downlink transmission simultaneously, the one or more processors are configured to cause the UE to:
process the second downlink transmission; and
process the third downlink transmission after finishing processing the second downlink transmission.

15. The UE of claim 12, wherein, in order to take the one or more actions, the one or more processors are configured to cause the UE to, regardless of the size of the buffer of the UE:
drop the second downlink transmission; and
based on dropping the second downlink transmission, process the third downlink transmission during the one or more gap slots.

16. The UE of claim 12, wherein:
one or more processors are further configured to cause the UE to receive a message including a preemption indicator associated with the third downlink transmission, wherein the preemption indicator indicates that processing of the third downlink transmission preempts processing of the second downlink transmission; and
in order to take the one or more actions, the one or more processors are configured to cause the UE to:
drop the second downlink transmission based on the preemption indicator associated with the third downlink transmission; and
based on dropping the second downlink transmission, process the third downlink transmission during the one or more gap slots.

17. The UE of claim 1, wherein:
the first peak throughput is based on a first set of communication parameters for transmission of at least the first downlink transmission;
the second peak throughput is based on a second set of communication parameters for transmission of at least the second downlink transmission; and
the second peak throughput is less than the first peak throughput based on a scaling factor included within the second set of transmission parameters.

18. A network entity, comprising:
one or more processors configured to execute instructions stored on one or more memories and to cause the network entity to:
transmit, to a user equipment (UE), a first control configuration that configures a first peak throughput for at least a first downlink transmission to be received by the UE;
transmit, to the UE, a second control configuration that configures at least:
a second peak throughput, for at least a second downlink transmission to be received by the UE, that is less than the first peak throughput indicated by the first control configuration; and
one or more gap slots that consecutively follow the second downlink transmission;
transmit, to the UE, at least the second downlink transmission in a first slot in accordance with the second control configuration, wherein a scheduled downlink transmission throughput associated with the first slot is less than the second peak throughput; and
transmit, to the UE, at least a third downlink transmission in the one or more gap slots based on the scheduled downlink transmission throughput associated with the first slot being less than the second peak throughput.

19. The network entity of claim 18, wherein the one or more gap slots are configured for the UE to process at least the second downlink transmission.

20. The network entity of claim 18, wherein:
the first control configuration indicates a first processing timeline for processing at least the first downlink transmission; and
the second control configuration indicates a second processing timeline for processing at least the second downlink transmission that is longer than the first processing timeline.

21. The network entity of claim 20, wherein a third processing timeline for processing the third downlink transmission is shorter than the second processing timeline indicated in the second control configuration.

22. The network entity of claim 21, wherein, based on the third processing timeline being shorter than the second processing timeline indicated in the second control configuration, at least one of:
a transport block size (TBS) of the third downlink transmission is less than a threshold TBS;
a rank of the third downlink transmission is less than a threshold rank;
a modulation an coding scheme (MCS) of the third downlink transmission is less than a threshold MCS;
a number of scheduled symbols of the third downlink transmission being below a threshold number of symbols; or
a number of scheduled resource blocks (RBs) of the third downlink transmission being below a threshold number of RBs.

23. The network entity of claim 18, wherein at least the third downlink transmission is transmitted when one or more conditions are satisfied.

24. The network entity of claim 23, wherein:
the one or more conditions comprise a transport block size (TBS) of the third downlink transmission being smaller than a threshold TBS; and
the one or more processors are further configured to cause the network entity to receive, from the UE, an indication of the threshold TBS.

25. The network entity of claim 23, wherein the one or more conditions comprise at least one of:
a rank of the third downlink transmission being below a threshold rank;
a modulation and coding scheme (MCS) of the third downlink transmission being below a threshold MCS;
a number of scheduled symbols of the third downlink transmission being below a threshold number of symbols; or
a number of scheduled resource blocks (RBs) of the third downlink transmission being below a threshold number of RBs.

26. The network entity of claim 23, wherein the one or more conditions comprise at least one of:
an aggregated bandwidth of the second downlink transmission and the third downlink transmission being equal to or below a maximum bandwidth;
an aggregated rank of the second downlink transmission and the third downlink transmission being equal to or below a maximum rank;
an aggregated number of symbols of the second downlink transmission and the third downlink transmission being equal to or below a maximum number of symbols;
an MCS of the second downlink transmission and an MCS of the third downlink transmission both being below respective maximum MCSs; or
an aggregated throughput of the second downlink transmission and the third downlink transmission being less than or equal to the second peak throughput.

27. The network entity of claim 18, wherein the one or more processors are further configured to cause the network entity to transmit a message including a preemption indicator associated with the third downlink transmission, wherein the preemption indicator indicates that processing of the third downlink transmission preempts processing of the second downlink transmission.

28. The network entity of claim 20, wherein:
the first peak throughput is based on a first set of communication parameters for transmission of at least the first downlink transmission;
the second peak throughput is based on a second set of communication parameters for transmission of at least the second downlink transmission; and
the second peak throughput is less than the first peak throughput based on a scaling factor included within the second set of transmission parameters.

29. A method for wireless communication by a user equipment (UE), comprising:
receiving, from a network entity, a first control configuration that configures a first peak throughput for at least a first downlink transmission to be received by the UE;
receiving, from the network entity, a second control configuration that configures at least:
a second peak throughput, for at least a second downlink transmission to be received by the UE, that is less than the first peak throughput indicated by the first control configuration; and
one or more gap slots that consecutively follow the second downlink transmission;
receiving, from the network entity, at least the second downlink transmission in a first slot in accordance with the second control configuration, wherein a scheduled downlink transmission throughput associated with the first slot is less than the second peak throughput; and
receiving, from the network entity, at least a third downlink transmission in the one or more gap slots based on the scheduled downlink transmission throughput associated with the first slot being less than the second peak throughput.

30. A method for wireless communication by a network entity, comprising:
transmitting, to a user equipment (UE), a first control configuration that configures a first peak throughput for at least a first downlink transmission to be received by the UE;
transmitting, to the UE, a second control configuration that configures at least:
a second peak throughput, for at least a second downlink transmission to be received by the UE, that is less than the first peak throughput indicated by the first control configuration; and
one or more gap slots that consecutively follow the second downlink transmission;
transmitting, to the UE, at least the second downlink transmission in a first slot in accordance with the second control configuration, wherein a scheduled downlink transmission throughput associated with the first slot is less than the second peak throughput; and
transmitting, to the UE, at least a third downlink transmission in the one or more gap slots based on the scheduled downlink transmission throughput associated with the first slot being less than the second peak throughput.
